(19) United States
(12) Patent Application Publication
(10) Pub. No.: US 2026/0306343 A1
(43) Pub. Date: Oct. 8, 2026

(54) MASSAGE DEVICE

(71) Applicant: Xiamen Vanfly Health Science & Technology Co., Ltd., Xiamen (CN)

(72) Inventors: QiXian Lin, Xiamen (CN); Yuhui Chen, Xiamen (CN); Ying Chen, Xiamen (CN)

(21) Appl. No.: 19/308,578

(22) Filed: Aug. 25, 2025

(30) Foreign Application Priority Data
Apr. 7, 2025 (CN) 202520634871.2
Apr. 7, 2025 (CN) 202520635225.8

(51) Int. Cl. A61H 9/00

(52) U.S. Cl. CPC A61H 9/0092; A61H 2201/1246; A61H 2201/14; A61H 2201/1635; A61H 2201/1669; A61H 2201/1695; A61H 2201/5056; A61H 2205/065; A61H 2205/067

(57) ABSTRACT

A massage device for hand is provided and includes a housing; and a finger massage structure configured for massaging at least one finger of a hand, the finger massage structure attached to the housing and reciprocatively movable between a first position and a second position, and the finger massage structure configured to receive the at least one finger, pressing the at least one finger, and releasing the at least one finger, wherein the finger massage structure moves back and forth along the at least one finger while pressing the at least one finger, thereby massaging the at least one finger.

This application claims priority to Chinese Patent Application No. 202520634871.2, filed on Apr. 7, 2025, and Chinese Patent Application No. 202520635225.8, filed on Apr. 7, 2025. The contents of all the aforementioned applications, including any intervening amendments thereto, are hereby incorporated herein fully by reference.

### TECHNICAL FIELD

The disclosure relates to the technical field of massage device, particularly to a massage device configured for a hand.

### BACKGROUND

With the improvement of living standards, people's demands for health preservation have been growing increasingly, and massaging, as an important health-preserving method, has attracted extensive attention and shows a huge market potential. At present, various kinds of massage devices have been provided, such as massage devices for massaging hands. However, most hand massage devices lead to poor user experience, and failing to meet diversified needs and therefore, product sales are generally poor.

### BRIEF DESCRIPTION OF DRAWINGS

Implementations of the present disclosure will now be described, by way of embodiment, with reference to the attached figures.

FIG. 1 is a perspective view of a massage device for a hand of the present disclosure.

FIG. 2 is an exploded view of the massage device for a hand shown in FIG. 1.

FIG. 3 is another exploded view of the massage device for a hand shown in FIG. 1, viewed from an alternative angle.

FIG. 4 is a deeply exploded view of the massage device for a hand shown in FIG. 1.

FIG. 5 is a cross-sectional view of a main body of the massage device for a hand shown in FIG. 2.

FIG. 6 is a view enlarging a portion of the main body of the massage device for a hand shown in FIG. 2.

FIG. 7 is a diagram of the portion of the main body of the massage device for a hand shown in FIG. 6, an upper housing of the main body is removed.

FIG. 8 is a view showing a portion of a bottom of the upper housing.

FIG. 9 is a view showing a portion of a bottom of the main body of the massage device for a hand shown in FIG. 2.

FIG. 10 is a cross-sectional view of a partial structure of the main body shown in FIG. 6.

FIG. 11 is a perspective view of a movable member of the main body shown in FIG. 4.

FIG. 12 is a view showing the main body shown in FIG. 2, the movable member is in a first position.

FIG. 13 is another view showing the main body shown in FIG. 12, the movable member is in the first position but viewed from an alternative angle.

FIG. 14 is a view showing the main body shown in FIG. 2, the movable member is in a second position.

FIG. 15 is another view showing the main body shown in FIG. 14, the movable member is in the second position but viewed from an alternative angle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

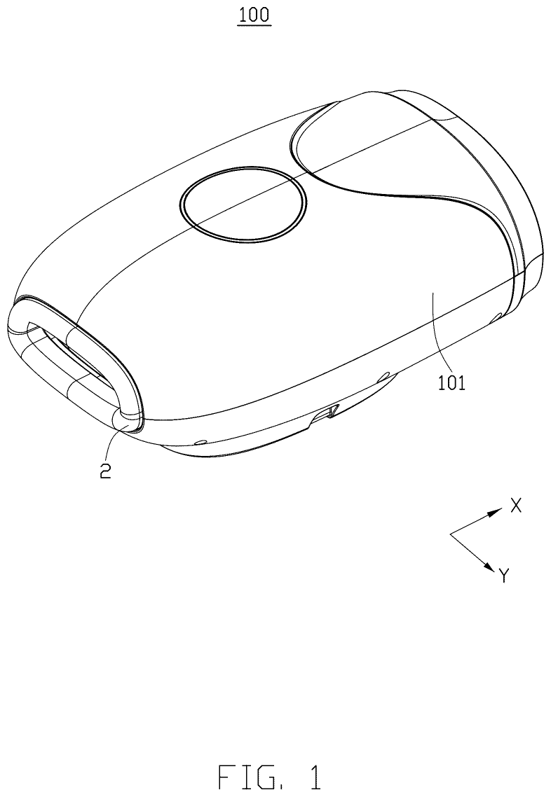

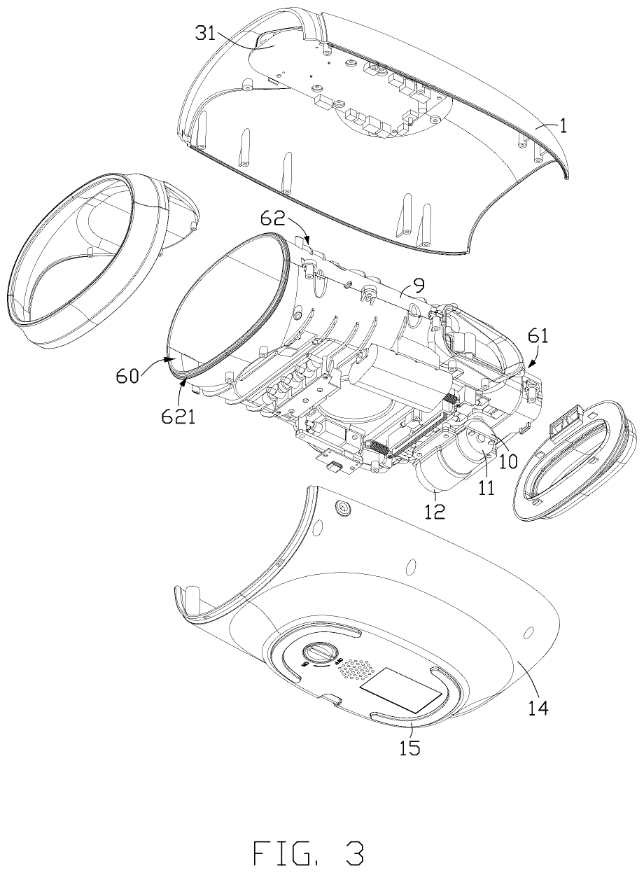

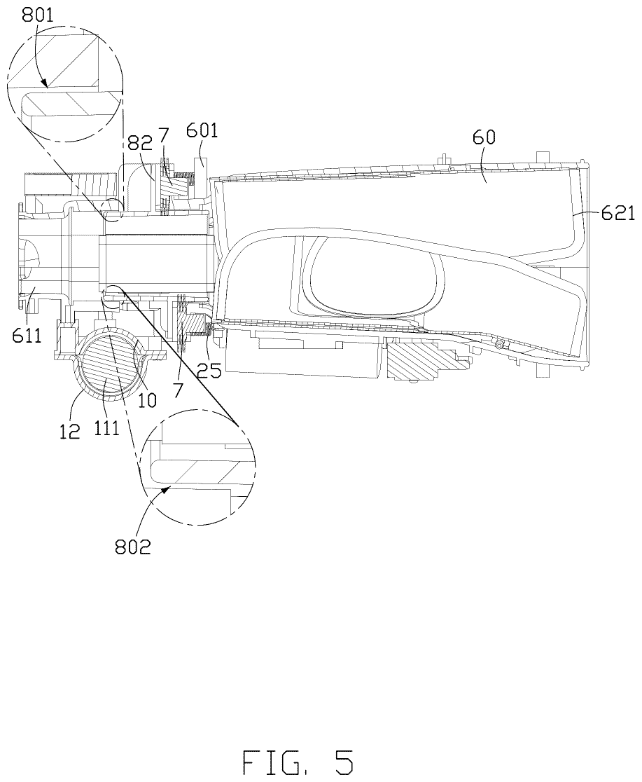

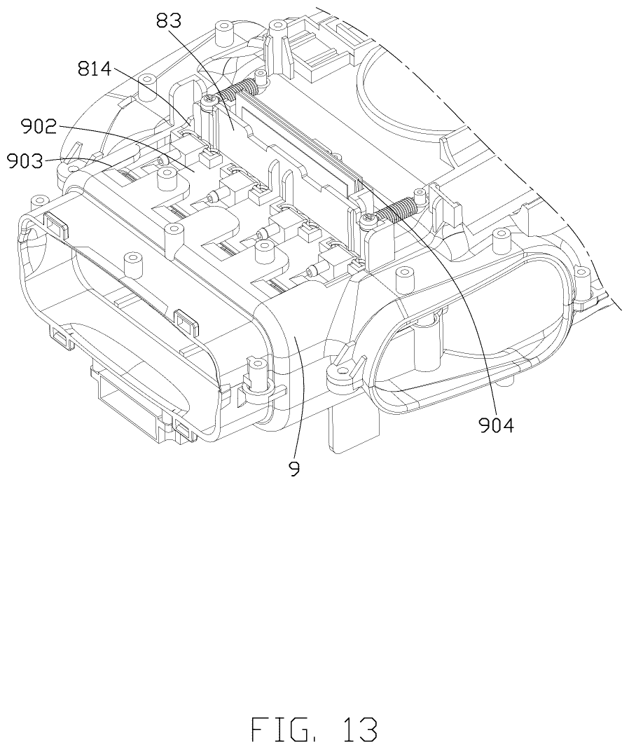

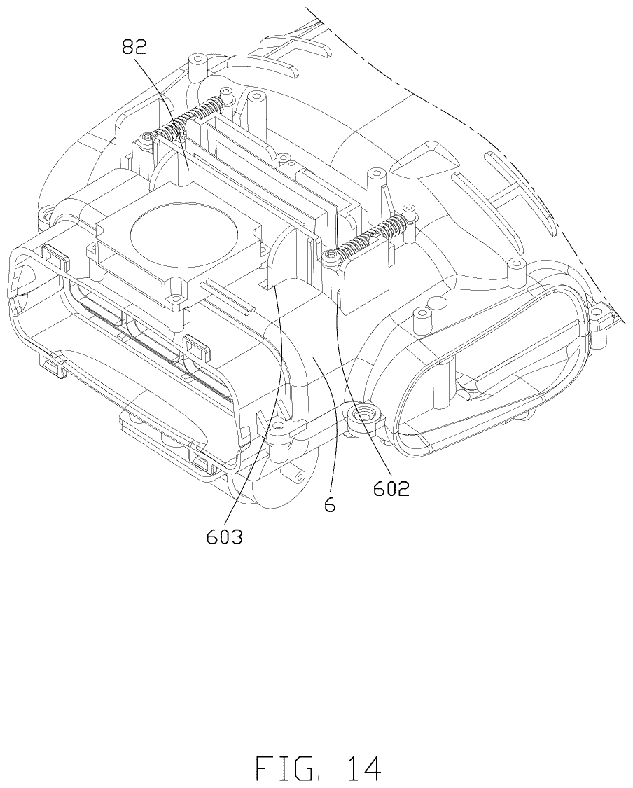

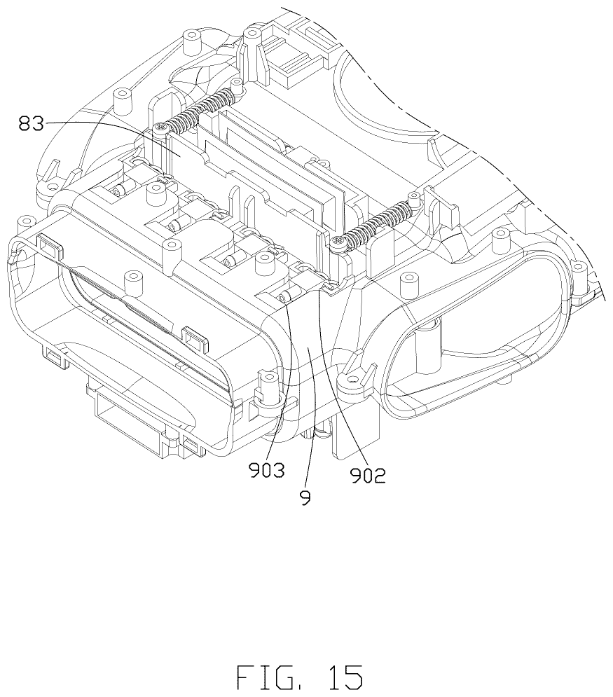

Referring to FIG. 1 to FIG. 15, the present disclosure provides a massage device 100 configured for a hand. The massage device 100 is used for massaging a hand of a user, and includes a casing 101, a main body 102, a finger massage structure 103 (first massage structure) configured for massaging at least one finger of the hand of a body, and a palm massage structure 104 (second massage structure) configured for massaging a palm of the hand of the body which is on the same hand of the fingers. The main body 102 is accommodated in the casing 101, and the finger massage structure 103 and the palm massage structure 104 are attached to the main body 102.

Referring to FIG. 1 to FIG. 3, the casing 101 includes an upper casing 1 and a lower casing 14. The upper casing 1 and the lower casing 14 are opposite and assembled to define a receiving cavity for receiving the main body 102 and an opening at a front side of the casing 1. The receiving cavity is in air communications with an exterior of the casing through the opening.

The main body 102 includes a housing 60, an air pump 11. The housing has a bracket 10 at an outer side, and the air pump 11 is mounted on the outer side of the housing 60 by the bracket 10. A cover 12 is attached to the air pump 11 and covers the air pump 11.

The housing 60 defines an accommodating cavity 601 for receiving the finger massage structure 103 and the palm massage structure 104. The accommodating cavity 601 includes a front area (first area) and a rear area (second area), the finger massage structure 103 is located in the front area for performing massaging on the at least one finger, and the palm massage structure 104 is located in the rear area for placing and massaging the palm which is located at the same hand with the fingers massaged by the finger massage structure 103. At least a portion of the finger massage structure 103 is movable in the housing 60 and movable towards and away from the palm massage structure 104 reciprocally when the finger massage structure 103 is massaging the at least one finger, that is, the at least the portion of the finger massage structure 103 moves back and forth along the finger while pressing the finger, so as to massage the finger.

In this embodiment, the housing 60 includes an upper housing 6 and a lower housing 9 coupled to the upper housing 6, and the accommodating cavity 601 is defined by a corporation of the upper housing 6 and the lower housing 9. The housing 60 includes a first end 61, such as a left end, and a second end 62, such as a right end, arranged opposite to the first end 61. The first end 61 defines a vent 611 opens towards left, and the second end 62 defines an insertion entrance 621 opens towards right. The vent 611 and the insertion entrance 621 are respectively located at opposite sides of the accommodating cavity 601 and air communicated with the accommodating cavity 601. The vent 611 is configured for ventilation, and the insertion entrance 621 is configured for allowing the hand to insert into the accommodating cavity 601. The finger massage structure 103 is disposed close to the vent 611, and the palm massage structure 104 is disposed close to the insertion entrance 621. When the hand extends into the accommodating cavity 601 through the insertion entrance 621, the palm is placed on the palm massage structure 104 and the fingers are extended into the finger massage structure 60. The at least the portion of the finger massage structure 103 moves back and forth alternately for generating a sensation of pulling and releasing the fingers when a finger massaging function is enabled by the user.

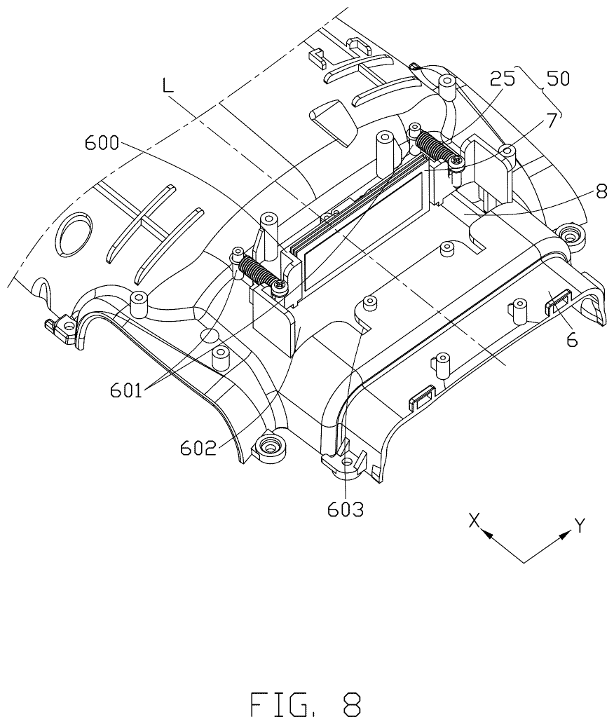

In this embodiment, referring to FIG. 8, the upper housing 6 defines a first opening 602 at an upper surface, and the first opening 602 is corresponding to the finger massage structure 103. A first wall 600 and a pair of first pins 601 upwardly extend from the top surface of the upper housing 6 and besides the first opening 602. The pair of first pins 601 are respectively located at opposite sides of the first wall 600, the pair of first pins 601 are symmetrically arranged relative to a central line L of the massage device 100.

Further, in the embodiment, the upper housing 6 is further provided with at least one first cutout 603. The at least one first cutout 603 is in air communicated with the first opening 602. In this embodiment, the upper housing 6 defines two first cutouts 603. In other embodiment, the number of the first cutout can be three or four, which is not limited herein. When the upper housing 6 defines at least two first cutouts 603, the at least two first cutouts 603 may be arranged in a parallel and at intervals.

Further, in this embodiment, the first opening 602 and the first cutouts 603 penetrates the upper housing 6 along an up-down direction.

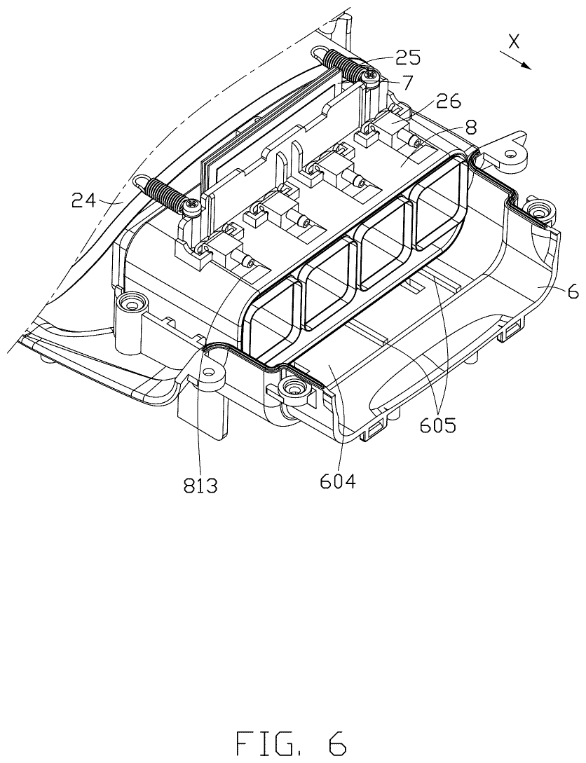

Further, referring to FIG. 6, a lower surface (first surface) 604 of the upper housing 6 facing the accommodating cavity 601 comprises at least one first rib 605. The at least one first rib 605 extends along a moving direction of the finger massage structure 60. In this embodiment, the moving direction is parallel to a longitudinal direction X of the massage device 100. The at least one first rib 605 is integrally formed with the lower surface 604 and protruding downward from the lower surface 604 of the upper housing 6. An upper surface of the finger massage structure 103 directly contacts the at least one first rib 605 and slides along the at least one first rib 605. Especially, the number of the first rib 605 is not less than two, and the first ribs 605 are arranged at intervals.

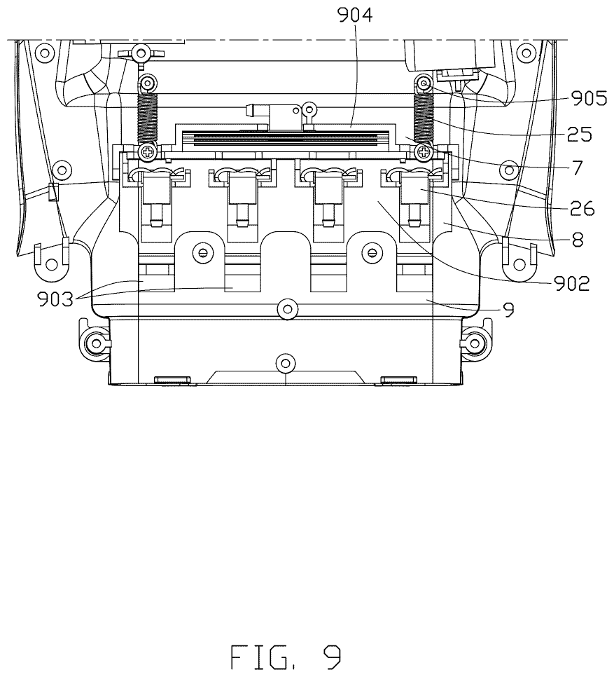

In this embodiment, referring to FIG. 9, the lower housing 9 defines a second opening 902, which is correspondingly disposed with the finger massage structure 103 and opposite to the first opening 602.

In this embodiment, the lower housing 9 is further provided with a plurality of second cutouts 903 arranged at intervals. The plurality of second cutouts 903 are in air communicated with the second opening 902. In this embodiment, the lower housing 9 defines four second cutouts 903. In other embodiment, the number of the second cutouts 903 can be five, which is not limited herein.

Further, in this embodiment, a lower surface of the lower housing 9 is further provided with a second wall 904 and a pair of second pins 905. The second wall 904 is positioned adjacent to the second opening 902 on a side opposite to the first end 61. The pair of second pins 905 are respectively located at outsides of opposite ends of the second wall 904, the pair of second pins 905 are symmetrically arranged relative to the central line L of the massage device 100.

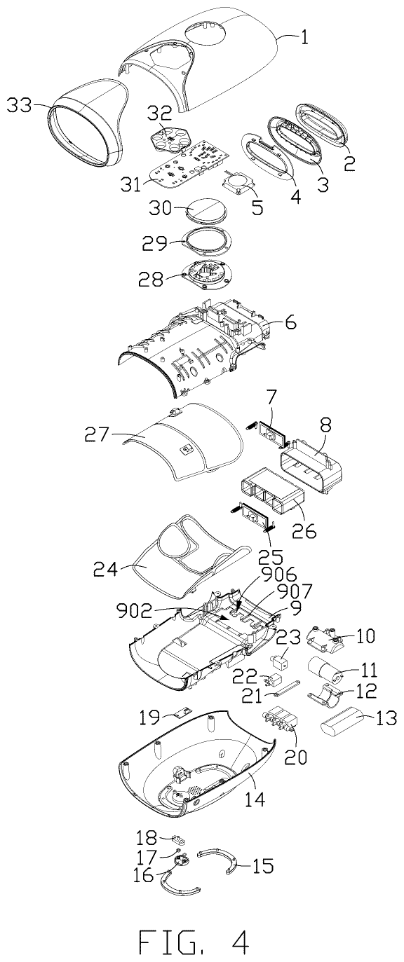

Further, in this embodiment, referring to FIG. 4, an upper surface (second surface) 906 of the lower housing 9 facing the accommodating cavity 601 comprises at least one second rib 906. The at least one second rib 907 extends along the longitudinal direction X of the massage device 100. The at least one second rib 907 is integrally formed with the upper surface 906 and protruding upward from the upper surface 906 of the lower housing 9. A bottom surface of the finger massage structure 103 directly contacts the at least one second rib 907 and slides on the at least one second rib 907. Especially, the number of the second rib 907 is not less than two, and the second ribs 906 are arranged at intervals.

The bracket 10 is mounted on a bottom of the housing. In this embodiment, the bracket 10 is arranged at the upper surface 906 of the lower housing 9.

The finger massage structure 103 includes a movable member 8, a finger massage portion 26, and a driving assembly 50. The movable member 8 is received in the housing 60 and makes reciprocative motions between a first position and a second position of the housing 60. The movable member 8 includes a receiving space 801 for accommodating the finger massage portion 26.

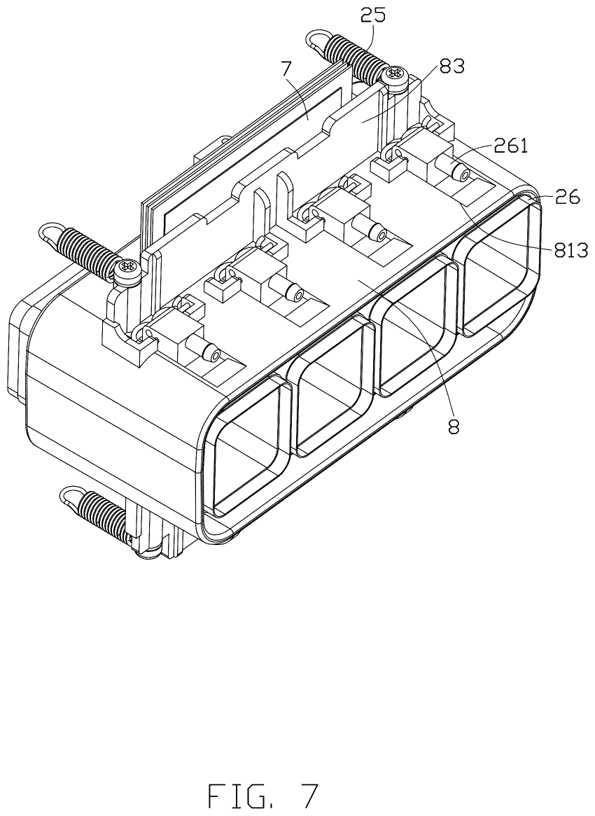

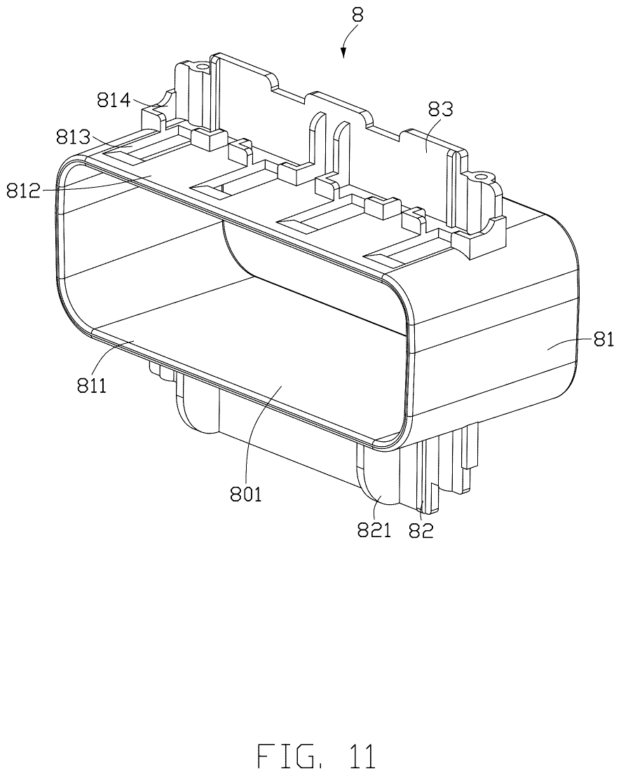

In this embodiment, referring to FIG. 7 and FIG. 11, the movable member 8 includes a frame 81, a first blocking portion 82, and a second blocking portion 83. The frame 81 may include a surrounding wall which defines a space for accommodating the finger massage portion 26. The frame 81 includes a first side wall 811 and a second side wall 812 which are oppositely arranged. The first side wall 811 is arranged corresponding to the upper housing 6 and in contact with the at least one first rib 605 of the upper housing 6, and the second side wall 812 is arranged corresponding to the lower housing 9 and in contact with the at least one second rib 907 of the lower housing 9, so as to reduce a contact area between the first side wall 811 and the upper housing 6 and a contact area between the second side wall 812 and the lower housing 9, thereby reducing the frictions between the frame 81 and the housing and reducing the sound generated when the movable member 8 moves. In addition, the movable member 8 moves within the housing 60 by directly sliding on the at least one first rib 605 and the at least one second rib 907, featuring a simple structure that eliminates the need for additional components to facilitate the movement of the movable member 8.

In this embodiment, due to of the first and second ribs 605 and 907, a first gap 801 is formed between the first side wall 811 and the first surface 604, a second gap 802 is formed between the second side wall 812 and the second surface 906, and a width of the first gap 801 and the second gap 802 are predefined in a range from 0.3 mm to 0.8 mm.

In other embodiment, either the first surface 604 or the second surface 906 is provided with the rib.

Further, the second side wall 812 defines a plurality of through holes 813 arranged at intervals and extending along the longitudinal direction X of the massage device 100, the plurality of through holes 813 are corresponding to the finger massage portion 26 and configured for allowing a portion of the finger massage portion 26 to pass through and extend to outside of the frame 81.

An edge of the plurality of through holes 813 close to the second blocking portion 83 is further provided with a plurality of mounting portions 814, each of the plurality of mounting portions 814 is configured for mounting the portion of the finger massage portion 26.

The first blocking portion 82 is arranged at the first side wall 811 and arranged opposite to the first wall 600, and the first blocking portion 82 perpendicularly extends from the first side wall 811 and configured to passe through the first opening 602 and movable in the first opening 602. In this embodiment, at least one extension portion 821 perpendicularly extends from a surface of the first blocking portion 82. In this embodiment, a plurality of extension portions 821 are arranged at intervals and in parallel, and configured for being inserted into a corresponding first cutout 603 of the upper housing 6 to extend a displacement distance of the movable member 8 and ensure that the upper housing 6 provides a sufficient surface to support the movement of the movable member 8. In this embodiment, the first blocking portion 82 is perpendicular to the first side wall 811 and is in the shape of a plate.

The second blocking portion 83 is arranged on the second side wall 812 and arranged opposite to the second wall 904, and the second blocking portion 83 extends from the second side wall 812 and is configured to pass through the second opening 902 and movable in the second opening 902. In this embodiment, the second blocking portion 83 is perpendicular to the second side wall 812 and is in the shape of a plate.

In this embodiment, the first blocking portion 82, the second blocking portion 83, and the frame 81 are integrally formed.

The finger massage portion 26 is fixedly mounted in the movable member 8 and adopts a sleeve-type structural design to completely wrap the fingers. In this embodiment, the finger massage portion 26 comprises a plurality of finger airbags corresponding to the index finger, middle finger, ring finger, and little finger, respectively. The plurality of finger airbags are sequentially arranged along a width direction Y of the massage device for hand, and each of the plurality of finger airbags includes a nozzle 261 coupled to a finger airbag of the plurality of finger airbags, so as to achieve individual control. In this embodiment, each the nozzle 261 configured for passing through one of the throughs hole 813 and exposing from the frame 81, and is fixed on the mounting portion 814 by a fastener. In this embodiment, the fastener may be a wave pin. In other embodiments, five finger airbags may be provided corresponding to all fingers.

The driving assembly 50 is configured for driving the movable member 8 to reciprocate between the first position and the second position. Both ends of the driving assembly 50 are respectively connected to the movable member 8 and the housing.

The driving assembly 50 includes at least one pushing member 7 and at least one elastic member 25. The pushing member 7 is positioned between the first wall 600 and the first blocking portion 82 and/or between the second wall 904 and the second blocking portion 83. In this embodiment, the pushing member 7 may be a bellows-type airbag, and expandable in the moving direction when being inflated, and an end of the pushing member 7 is connected to the movable member 8.

The elastic member 25 is configured for pulling the movable member 8 back to the first position when the movable member 8 has moved to the second position. In this embodiment, opposite sides of the elastic member 25 are respectively connected to the housing 60 and the movable member 8. In this embodiment, the elastic member 25 is a spring, and both ends of the spring are respectively connected to a pin of the housing and the movable member 8.

In this embodiment, the driving assembly includes two pushing members 7 located at an upper side and a lower side of the movable member 8, two pair of elastic members 25. A pair of elastic members 25 are arranged on opposite sides of the pushing member 7 located at the upper housing 6 and the other pair of elastic members 25 are arranged on opposite sides of the pushing member 7 located at the lower housing 9, thereby achieving force balance in the up-down direction.

In the present disclosure, the movable member 8 is arranged in the accommodating cavity 601 and movable between the upper housing 6 and the lower housing 9, without arranging additional independent components such as a traditional moving frame and a limiting frame to help moving, thereby greatly reducing the volume of the mechanism.

Further, the first and second blocking portions 82, 83 of the movable member 8 pass through the first and second openings 602, 902 respectively and movable in the first and second openings 602, 902 respectively, the ends of the elastic members 25 are respectively connected to the housing 60 and the first blocking portion 82 or the second blocking portion 83, and the pushing member 7 are connected to the housing 60 and the first blocking portion 82. The first opening 602 and the second opening 902 have configurations for limiting and guiding the move of the movable member 8 along the longitudinal direction X of the massage device for hand.

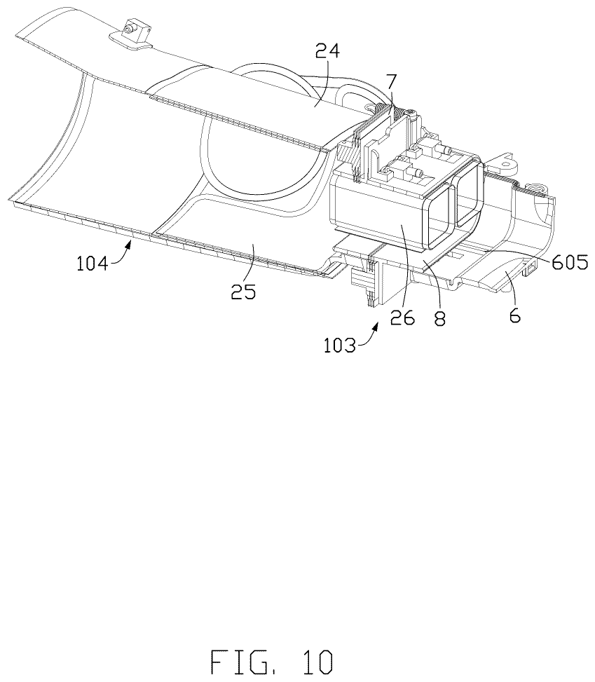

Referring to FIG. 4 and FIG. 10, the palm massage structure 104 includes an upper airbag (first airbag) 27 arranged on the upper housing 6 and a lower airbag (second airbag) 24, which are opposite to each other. Further, the upper airbag 27 is arranged on the upper housing 6, and the lower airbag 24 is mounted on the lower housing 9. A palm massage space is defined between the upper airbag 27 and the lower airbag 24, the palm massage space is configured to accommodate the palm, and the upper airbag 27 and the lower airbag 24 are configured to cooperatively massage the palm in the palm massage space. The upper airbag 27 and the lower airbag 24 are communicated with the air pump through air pipes (not shown).

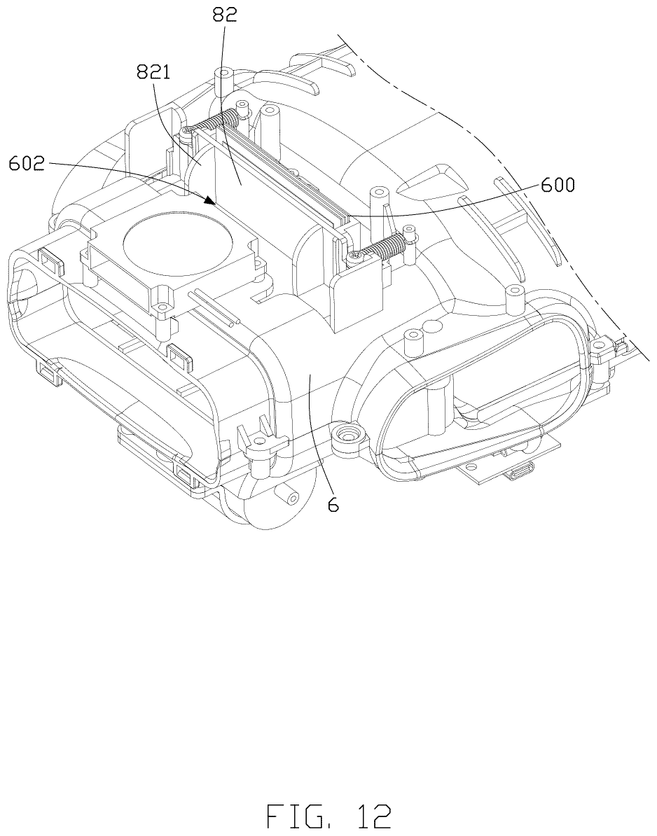

Referring to FIG. 12 to FIG. 15, the working principle of the massage device for hand of the present disclosure is as follows. When the massage device for hand is in an unpowered state, the movable member 8 in the first position, and the upper airbag 27, the lower airbag 24, the finger airbags and the pushing member 7 are in a deflated state. When the massage device for hand is activated, the air pump 11 concurrently inflates the upper airbag 27 and the lower airbag 24 and the finger airbags, and maintains pressures of the upper airbag 27 and the lower airbag 24 and the finger airbags through a pressure-holding air valve to complete the preliminary fixing of the hand. Subsequently, the finger airbags and the movable member 8 are reciprocated between the first position and the second position under a combined action of a pushing force from the pushing member 7 and the pulling force from the elastic member 25, so as to effectively avoid the offset of the hand during stretching and ensuring that the traction force is concentrated on the finger joints.

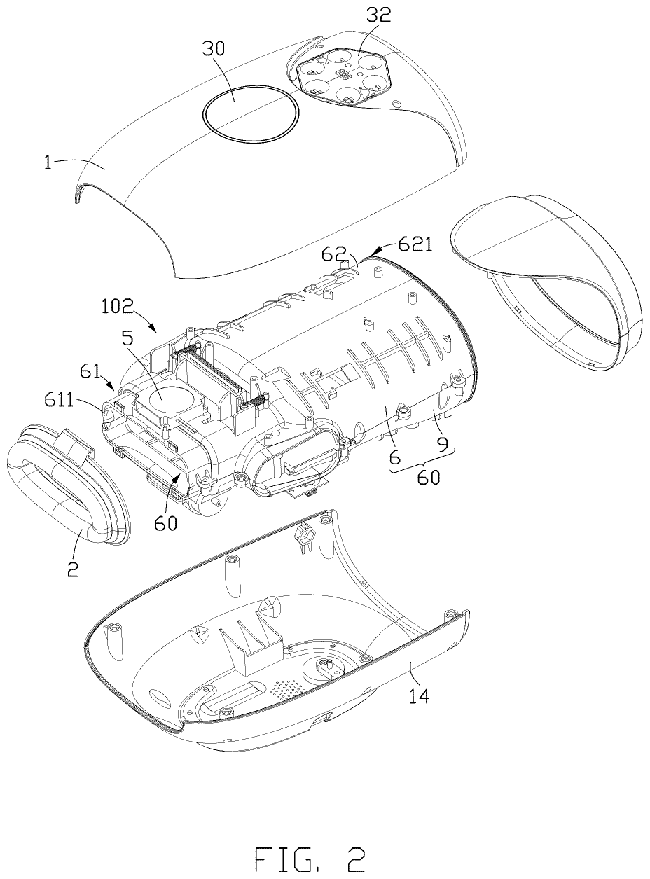

In this embodiment, referring to FIG. 2 and FIG. 4, the massage device 100 further includes a first ring 2, a first air duct shell 3, a second air duct shell 4, and a fan 5 arranged at the front side of the casing 101. The first ring 2 serves as a front-end exterior component, and configured for decorating and protecting edges of the casing 101. The first air duct shell 3 and the second air duct shell 4 form a channel for guiding airflow. The fan 5 is configured to reduce a working temperature of heating components such as the air pump 11 by rotating fan blades (not shown) to promote internal air circulation in the receiving cavity. The massage device 100 further includes a second ring 33 arranged at a rear side of the casing 101.

The massage device 100 further includes a pad 15 located at bottom of the casing 101 and configured to support the massage device 100 and prevent the massage device 100 from sliding during use, an air pipe joint 18 configured to connect external air pump pipelines, a sealing ring 17 configured to ensure air circuit sealing, and a knob 16 configured to adjust an opening degree of an air valve by rotating the knob 16. When an electronic control system of the massage device 100 fails, the knob 16 can be manually rotated to a maximum opening to achieve emergency air release, ensuring safety during use.

Furthermore, referring to FIG. 2 and FIG. 4, The massage device 100 further includes a display panel 30 and a control board 31 arranged on the upper housing 6. The control board 31 is electrically connected to the display panel 30 and the air pump 11. The control board 31 integrates operation buttons, and the upper shell 1 is provided with a corresponding hollow portion for installing the display panel 30 and the buttons. Bottom of the display panel 30 is provided with a panel light-shielding member 28, and a panel decorative ring 29 is arranged on a periphery of the display panel 30. The buttons on the control board 31 are covered with a button light-shielding member 32. In addition, a battery 13 and a charging board 19 are further disposed within the casing 101 to supply power to the air pump 11.

What is claimed is:

1. A massage device configured for a hand comprising:
a housing; and
a finger massage structure configured for massaging at least one finger of a hand, the finger massage structure attached to the housing and reciprocatively movable between a first position and a second position, and the finger massage structure configured to receive the at least one finger, pressing the at least one finger, and releasing the at least one finger,
wherein the finger massage structure moves back and forth along the at least one finger while pressing the at least one finger, thereby massaging the at least one finger.

2. The massage device according to claim 1, wherein the housing comprises a first surface and a second surface arranged opposite to the first surface, at least one of the first surface and the second surface comprises at least one rib, the at least one rib extends along a moving direction of the finger massage structure, the finger massage structure directly contacts the at least one first rib and is slidable on the at least one first rib.

3. The massage device according to claim 2, wherein both of the first surface and the second surface comprises the at least one ribs, a first gap is formed between the first side wall and the first surface, a second gap is formed between the second side wall and the second surface.

4. The massage device according to claim 1, wherein the finger massage structure comprises:
a movable member attached to the housing and reciprocatively movable between the first position and the second position in the housing; and
at least one finger airbag attached to the movable member, the at least one finger airbag defines at least one receiving portion configured for receiving the at least one finger, wherein the at least one finger airbag presses the at least one finger received in the at least one receiving portion and moves together with the movable member when the at least one finger airbag is inflated.

5. The massage device according to claim 4, wherein the housing comprises an upper housing and a lower housing coupled to the upper housing, an accommodating cavity is formed between the upper housing and the lower housing and configured to receive the finger massage structure, at least one of the lower housing and the upper housing defines an opening,
the movable member comprises a first side wall and a second side wall arranged opposite to the first side wall, at least one of the first side wall and the second side wall is provided with a blocking portion, and the blocking portion passes through the corresponding opening and is movable within the opening.

6. The massage device according to claim 5, wherein the opening comprises a first opening defined in the upper housing;
the upper housing comprises at least one first cutout communicated with the first opening, at least one extension portion perpendicularly extends from a surface of the blocking portion and is insertable into the at least one first cutout of the upper housing.

7. The massage device according to claim 5, wherein the second side wall of the movable member defines a plurality of through holes arranged at intervals and extending along a longitudinal direction of the massage device,
the at least one finger airbag including a plurality of finger airbags, the finger massage structure further comprises a plurality of nozzles, each of the plurality of nozzles is coupled to a finger airbag of the plurality of finger airbags and configured for passing through one of the plurality of through holes and exposing from the second side wall.

8. The massage device according to claim 7, wherein the at least one opening comprises a second opening,
the second opening is defined in the lower housing, the lower housing further comprises a plurality of second cutouts communicated with the second opening, and when the movable member is located at the second position, each of the plurality of nozzles is located in a corresponding second cutout of the plurality of second cutouts.

9. The massage device according to claim 4, further comprising a driving assembly configured for driving the movable member to reciprocate between the first position and the second position.

10. The massage device according to claim 9, wherein the driving assembly comprises:
at least one pushing member configured for pushing the movable member to reciprocatively move between the first position and the second position; and
at least one elastic member configured for pulling the movable member to the first position when the movable member is moved to the second position.

11. The massage device according to claim 1, further comprising a palm massage structure fixedly arranged adjacent to the finger massage structure and in the housing, and configured for placing and massaging a palm of the hand of the at least one finger.

12. The massage device according to claim 11, wherein the palm massage structure comprises a first airbag and a second airbag arranged opposite to the first airbag, a palm massage space is defined between the upper airbag and the lower airbag, the palm massage space is configured to accommodate the palm, the first airbag and the second airbag are configured to cooperatively massage the palm in the palm massage space.

13. A massage device configured for a hand, the massage device comprising:
a housing;
a first massage structure accommodated in the housing and configured for massaging at least one finger of the hand,
a second massage structure accommodated in the housing and configured for massaging a palm of the hand,
wherein the first massage structure is movable towards and away from the second massage structure reciprocally when the first massage structure is massaging the at least one finger.

14. The massage device according to claim 13, wherein the second massage structure comprises a first airbag and a second airbag, a palm massage space is defined between the upper airbag and the lower airbag, the palm massage space is configured to accommodate the palm, the first airbag and the second airbag are configured to cooperatively massage the palm in the palm massage space.

15. The massage device according to claim 13, wherein the housing comprises a first surface and a second surface arranged opposite to the first surface, at least one of the first surface and the second surface comprises at least one rib, the at least one rib extends along a moving direction of the first massage structure, the first massage structure directly contacts the at least one first rib and is slidable on the at least one first rib.

16. The massage device according to claim 15, wherein both of the first surface and the second surface comprises the at least one ribs, a first gap is formed between the first side wall and the first surface, and a second gap is formed between the second side wall and the second surface.

17. The massage device according to claim 13, wherein the first massage structure comprises:
a movable member attached to the housing and reciprocatively movable between a first position and a second position in the housing, and the movable member defines a receiving space; and
at least one finger airbag attached to the movable member, the at least one finger airbag defines at least one receiving portion configured for receiving the at least one finger, the at least one finger airbag presses the at least one finger received in the at least one receiving portion and moves together with the movable member when the at least one finger airbag is inflated.

18. The massage device according to claim 17, wherein the housing defines at least one opening,
the movable member comprises a first side wall and a second side wall arranged opposite to the first side wall, at least one of the first side wall and the second side wall is provided with a blocking portion, and the blocking portion passes through the corresponding one of the at least one opening and is movable within the opening.

19. The massage device according to claim 17, wherein the first massage structure comprises a driving assembly configured for driving the movable member to reciprocate between the first position and the second position.

20. The massage device according to claim 19, wherein the driving assembly comprises:
a pushing member configured for driving the movable member to reciprocate between the first position and the second position; and
an elastic member configured for pulling the movable member to the first position when the movable member is moved to the second position.
